(19) United States
(12) Patent Application Publication
(10) Pub. No.: US 2010/0097728 A1
(43) Pub. Date: Apr. 22, 2010

(54) HEAD SUSPENSION ASSEMBLY AND STORAGE MEDIUM DRIVE APPARATUS

(75) Inventor: Shinji KOGANEZAWA, Atsugi-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/648,266

(22) Filed: Dec. 28, 2009

Related U.S. Application Data
(63) Continuation-in-part of application No. PCT/JP2007/063141, filed on Jun. 29, 2007.

(51) Int. Cl. G11B 21/24

(52) U.S. Cl. 360/294.4; G9B/21.028

(57) ABSTRACT

According to one embodiment, a head suspension assembly includes: a head slider; a fixed piece configured to be fixed to the head slider; a flexible long piece configured to extend from the fixed piece and to be connected to a head suspension; an arm piece configured to be connected to the head suspension at one end and slidably contact a surface of the head slider at other end; and a piezo element configured to be attached to the arm piece.

### CROSS-REFERENCE TO RELATED APPLICATIONS

This application is a continuation of PCT international application Ser. No. PCT/JP2007/063141 filed on Jun. 29, 2007 which designates the United States, incorporated herein by reference.

### BACKGROUND

1. Field

One embodiment of the invention relates to a head suspension assembly installed in, for example, a storage medium drive apparatus such as a hard disk drive apparatus (HDD).

2. Description of the Related Art

For example, Japanese Patent Application (KOKAI) No. 2003-228929 discloses an actuator that is fixed to a surface of a head suspension. The actuator includes a pair of arms supporting a head slider. The top end of the arm is bonded to the head slider. A piezo element is attached to the arm. The arm bends due to extension and contraction of the piezo element. The head slider is displaced along the surface of the head suspension due to the bending. The deviation of an electromagnetic conversion element on the head slider from the center line of a recording track is eliminated. Japanese Patent Application Publication (KOKAI) No. 2000-100097 and Japanese Patent Application Publication (KOKAI) No. 2005-28554 also correspond to the similar conventional technology.

In this actuator, the top end of the arm to which the piezo element is attached is bonded to the side surface of the head slider. The bending or deformation of the arm is restricted on the basis of the bonding despite the extension and contraction of the piezo element. The amount of displacement of the head slider is largely restricted.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view schematically illustrating an internal structure of a storage medium drive apparatus or a hard disk drive apparatus (HDD) according to a first embodiment of the invention;

FIG. 2 is an exemplary partial enlarged perspective view schematically illustrating a structure of a head suspension assembly in the first embodiment;

FIG. 3 is an exemplary perspective view schematically illustrating a structure of a micro actuator in the first embodiment;

FIG. 4 is an exemplary plan view schematically illustrating a structure of the micro actuator in the first embodiment;

FIG. 5 is an exemplary plan view schematically illustrating a structure of the micro actuator in the first embodiment;

FIG. 6 is an exemplary graph illustrating voltage values of voltages applied to a piezo element in the first embodiment;

FIG. 7 is an exemplary graph illustrating voltage values of voltages applied to the piezo element in the first embodiment;

FIG. 8 is an exemplary plan view schematically illustrating a rotation of a flying head slider in a clockwise direction in the first embodiment;

FIG. 9 is an exemplary plan view schematically illustrating a rotation of the flying head slider in the clockwise direction in the first embodiment;

FIG. 10 is an exemplary plan view schematically illustrating a rotation of the flying head slider in a counter-clockwise direction in the first embodiment;

FIG. 11 is an exemplary plan view schematically illustrating a rotation of the flying head slider in the counter-clockwise direction in the first embodiment;

FIG. 12 is an exemplary graph illustrating voltage values of voltages applied to the piezo element according to a first modified embodiment of the invention;

FIG. 13 is an exemplary perspective view schematically illustrating a structure of a micro actuator according to a second modified embodiment of the invention;

FIG. 14 is an exemplary plan view schematically illustrating a structure of a micro actuator according to a third modified embodiment of the invention; and

FIG. 15 is an exemplary perspective view schematically illustrating a structure of a micro actuator according to a second embodiment of the invention.

### DETAILED DESCRIPTION

Various embodiments according to the invention will be described hereinafter with reference to the accompanying drawings. In general, according to one embodiment of the invention, a head suspension assembly, includes: a head slider; a fixed piece configured to be fixed to the head slider; a flexible long piece configured to extend from the fixed piece and to be connected to a head suspension; an arm piece configured to be connected to the head suspension at one end and slidably contact a surface of the head slider at other end; and a piezo element configured to be attached to the arm piece.

According to another embodiment of the invention, a storage medium drive apparatus includes a head suspension assembly.

The head suspension assembly includes: a head slider faced to the storage medium; a fixed piece configured to be fixed to the head slider; a flexible long piece configured to extend from the fixed piece and to be connected to a head suspension; an arm piece configured to be connected to the head suspension at one end and slidably contact a surface of the head slider at the other end; and a piezo element configured to be attached to the arm piece.

Hereinafter, embodiments of the invention will be described with reference to the accompanying drawings.

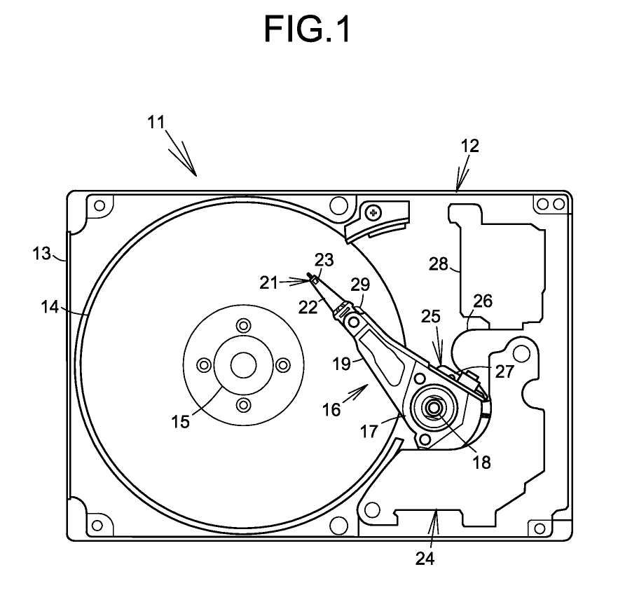

FIG. 1 is a schematic plan view of an internal structure of a first embodiment of a storage medium drive apparatus according to the invention, namely a hard disk drive apparatus (HDD) 11. The HDD 11 includes a housing 12. The housing 12 is constituted by a box-shape base 13 and a cover (not illustrated in FIG. 1). The base 13 forms, for example, a flat rectangular solid internal space, in other words, an accommodation space. For example, the base 13 may be molded from a metal material such as Aluminum by casting. The cover is joined to the opening of the base 13. The accommodation space is sealed between the cover and the base 13. For example, the cover may be molded from a piece of plate material on the basis of press working.

In the accommodation space, one or more magnetic disks 14 as storage media are accommodated. The magnetic disk 14 is mounted on a spindle motor 15. The spindle motor 15 can rotate the magnetic disk 14 at high speed such as, for example, 3600 round per minute (rpm), 4200 rpm, 5400 rpm, 7200 rpm, 10000 rpm, and 15000 rpm.

In the accommodation space, a carriage 16 is further accommodated. The carriage 16 includes a carriage block 17. The carriage block 17 is rotatably connected to a support shaft 18 extending in the vertical direction. In the carriage block 17, a plurality of carriage arms 19 extended from the support shaft 18 in the horizontal direction are separately arranged. The carriage block 17 may be molded from Aluminum by an extrusion molding method.

A head suspension assembly 21 is attached to the top end of each carriage arm 19. The head suspension assembly 21 includes a head suspension 22 extended forward from the top end of the carriage arm 19. A flexure described below is attached to the surface of the head suspension 22. A flying head slider 23 is supported on the flexure. A magnetic head, in other words, an electromagnetic conversion element is mounted on the flying head slider 23.

When an air flow is generated due to the rotation of the magnetic disk 14, a positive pressure, which is a buoyancy, and a negative pressure are applied to the flying head slider 23 by the effect of the air flow. Since the buoyancy, the negative pressure, and a pressing force of the head suspension 22 are balanced, the flying head slider 23 can continue flying with relatively high rigidity when the magnetic disk 14 rotates.

When the flying head slider 23 is flying, if the carriage 16 rotates around the support shaft 18, the flying head slider 23 can move along a radial line of the magnetic disk 14. As a result, the electromagnetic conversion element on the flying head slider 23 can move across a data zone between the innermost recording track and the outermost recording track. In this way, the electromagnetic conversion element on the flying head slider 23 is positioned on a target recording track.

A drive source such as, for example, a voice coil motor (VCM) 24 is connected to the carriage block 17. The carriage block 17 can rotate around the support shaft 18 by the operation of the VCM 24. A swing movement of the carriage arms 19 and the head suspension 22 is realized on the basis of the rotation of the carriage block 17.

As obvious from FIG. 1, a flexible printed circuit board module 25 is arranged on the carriage block 17. The flexible printed circuit board module 25 includes a head integrated circuit (IC) 27 mounted on a flexible printed circuit board 26. When reading magnetic information, a sense current is provided from the head IC 27 toward a read head element of the electromagnetic conversion element. In a similar way, when writing magnetic information, a write current is provided from the head IC 27 toward a write head element of the electromagnetic conversion element. The sense current and the write current are provided to the head IC 27 from a small-sized circuit board 28 arranged in the accommodation space and a printed circuit board (not illustrated in the figures) attached to the back side of a bottom plate of the base 13.

When providing the sense current and the write current, a flexure 29 is used. As described below, a wiring pattern is formed on the flexure 29. The flexure 29 is partially attached to each head suspension 22 at an end of the flexure 29. The flexure 29 extends backward from the head suspension 22 along the side edge of the carriage arm 19. The rear end of the flexure 29 is overlapped onto the flexible printed circuit board 26. The flexure 29 is connected to the flexible printed circuit board module 25. As a result, the sense current and the write current are provided from the head IC 27 to the flying head slider 23 by the wiring pattern. The head suspension assembly 21 is configured to be a so-called long tail type.

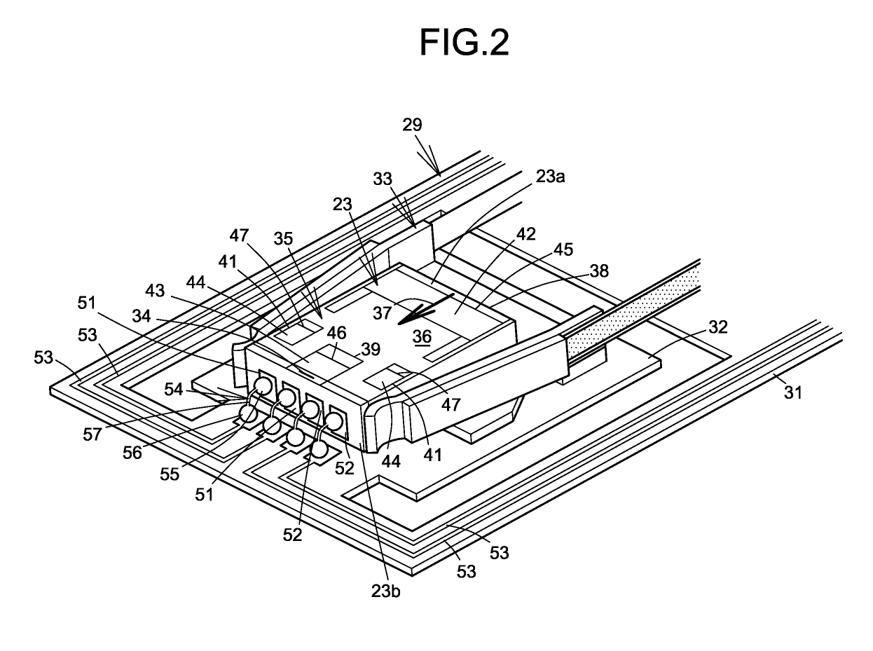

FIG. 2 illustrates the head suspension assembly 21 of the first embodiment. In the head suspension assembly 21, the flexure 29 includes a fixed plate 31 fixed to the head suspension 22. A gimbal 32 is connected to the fixed plate 31. The gimbal 32 can change its posture relative to the fixed plate 31. The fixed plate 31 and the gimbal 32 are constituted by a single plate spring member. The plate spring member may be constituted by, for example, a stainless steel plate having a uniform thickness. A micro actuator 33 is fixed to the surface of the gimbal 32. The micro actuator 33 supports the flying head slider 23. The details of the micro actuator 33 will be described below.

The flying head slider 23 includes a slider main body 23a which is formed into, for example, a flat rectangular solid. At an air outflow edge surface of the slider main body 23a, non-magnetic films, which are element-embedded films 23b, are laminated. An electromagnetic conversion element 34 described above is embedded in the element-embedded film 23b. The slider main body 23a may be formed from a hard non-magnetic material such as, for example, Al₂O₃—TiC (AlTiC). The element-embedded film 23b may be formed from a relatively soft non-magnetic material such as, for example, Al₂O₃ (Alumina).

The flying head slider 23 faces the magnetic disk 14 on the medium-facing surface, in other words, on a flying surface 35. A flat base surface 36 is defined on the flying surface 35. When the magnetic disk 14 rotates, an air flow 37 is applied to the flying surface 35 from the front edge to the rear edge of the slider main body 23a.

On the flying surface 35, a front rail 38 which rises from the base surface 36 is formed on the upstream side of the air flow 37 described above, which is the air inflow side. The front rail 38 extends along the air inflow edge of the base surface 36 in the slider width direction. In a similar way, on the flying surface 35, a rear rail 39 which rises from the base surface 36 is formed on the downstream side of the air flow, which is the air outflow side. The rear rail 39 is arranged at the center position in the slider width direction. The rear rail 39 extends from the slider main body 23a to the element-embedded film 23b. On the flying surface 35, a left-right pair of auxiliary rear rails 41, 41 which rise from the base surface 36 are further formed on the air outflow side. The rear rail 39 is arranged between the auxiliary rear rails 41, 41.

So-called air bearing surfaces (ABS) 42, 43, and 44 are defined on the top surface of the front rail 38, the rear rail 39, and the auxiliary rails 41, 41. The air inflow edges of the ABS 42, 43, 44 are connected to the top surfaces of the rails 38, 39, 41 via the steps 45, 46, 47. The air flow 37 generated on the basis of the rotation of the magnetic disk 14 is caught by the flying surface 35. At this time, a relatively large positive pressure, which is buoyancy, is generated on the ABS 42, 43, 44 by the effect of the steps 45, 46, 47. Furthermore, a large negative pressure is generated behind or backward of the front rail 38. The flying posture of the flying head slider 23 is established on the basis of the balance between the buoyancy and the negative pressure.

The electromagnetic conversion element 34 is embedded in the rear rail 39. The electromagnetic conversion element 34 is exposed on the ABS 44. For example, the electromagnetic conversion element 34 may be constituted by a read head element such as a giant magnetoresistance effect (GMR) element and a tunnel junction magnetoresistance effect (TMR) element, and a write head element such as a thin-film magnetic head used when writing information to the magnetic disk 14. The configuration of the flying head slider 23 is not limited to the above described configuration.

Two pairs of electrode terminals 51, 52 are arranged on the air outflow edge surface of the flying head slider 23 or the element-embedded film 23b. For example, the pair of electrode terminals 51 is electrically connected to the read head of the electromagnetic conversion element 34. In this way, the sense current is provided to the read head element from the pair of electrode terminals 51. The voltage variation of the sense current is obtained from the electrode terminals 51. For example, the other pair of electrode terminals 52 is electrically connected to the write head of the electromagnetic conversion element 34. A write current is provided to the write head element from the electrode terminals 52. A magnetic field is generated, for example, in a thin film coil pattern, depending on the provision of the write current.

The described wiring pattern 53 is formed on the flexure 29. The wiring pattern 53 and the electrode terminals 51, 52 are connected to each other by a conductive wire 54. Each conductive wire 54 includes a first contact 55 standing upright from the surface of the electrode terminals 51, 52, and a second contact 56 standing upright from the surface of the wiring pattern 53. The first and the second contacts 55 and 56 are connected to each other by a wire main body 57. The angle difference of 90 degrees between the first and the second contacts 55 and 56 is taken into account by the bending of the wire main body 57. A so-called wire bonding method is used to form the conductive wire 54. The flexure 29 includes a stainless steel plate, and an insulation layer, the wiring pattern 53, and a protective layer which are laminated sequentially on the stainless steel plate. For example, a resin material such as a polyimide resin may be used for the insulation layer and the protective layer.

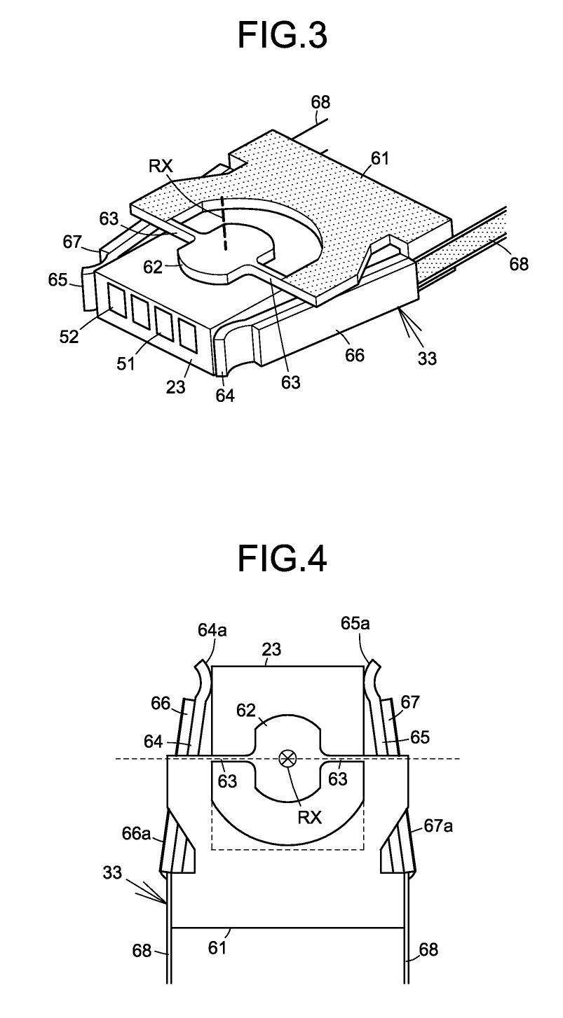

As illustrated in FIG. 3, the micro actuator 33 includes a base piece 61 having a flat-plate shape. The base piece 61 is attached to the gimbal 32 on the entire surface thereof. The base piece 61 supports a fixed piece 62. The fixed piece 62 is attached to the back surface of the flying head slider 23. The fixed piece 62 extends around a rotation axis RX perpendicular to a flying surface 35. Here, the rotation axis RX passes through the gravity center of the flying head slider 23. The base piece 61 and the fixed piece 62 are combined by flexible long pieces 63, 63.

Further referring to FIG. 4, the long pieces 63, 63 are set to the same length. The long piece 63 is arranged along a virtual straight line perpendicular to the rotation axis RX in the width direction of the flying head slider 23. The virtual straight line extends in parallel with the air inflow edge and the air outflow edge of the flying head slider 23. The long piece 63 can bend. As described below, the long piece 63 allows the fixed piece 62 to rotate around the rotation axis RX on the basis of the bending. On the other hand, since the base piece 61 is fixed to the gimbal 32 of the flexure 29, bending of the base piece 61 is avoided despite the rotation of the fixed piece 62. In a similar way, since the fixed piece 62 is fixed to the flying head slider 23, bending of the fixed piece 62 is avoided despite the rotation.

A first and a second arm pieces 64, 65 are combined with the base piece 61. One end, which is a base end, of the first and the second arm pieces 64, 65 is combined with the base piece 61 on the upstream side of the air inflow edge of the flying head slider 23. The other end, which is a top end, of the first and the second arm pieces 64, 65 is caught by the side surface of the flying head slider 23 on the downstream side of the rotation axis RX. The flying head slider 23 is arranged in a space partitioned between the first and the second arm pieces 64 and 65. The first arm piece 64 extends along a virtual plane defined in parallel with the rotation axis RX. In a similar way, the second arm piece 65 also extends along a virtual plane defined in parallel with the rotation axis RX.

The inside surfaces of the first and the second arm pieces 64, 65 face each other. The first and the second arm pieces 64, 65 are arranged closer to each other toward the top end from the base end. In the top end of the first and the second arm pieces 64, 65, cylindrical surfaces 64a, 65b drawn around center axes parallel with the side surfaces of the flying head slider 23 are defined. The center axes are defined in parallel with the rotation axis RX. The first and the second arm pieces 64, 65 linearly contact the side surfaces of the flying head slider 23 at the cylindrical surfaces 64a, 65b.

A first piezo element 66 is attached to the outside surface of the first arm piece 64. In a similar way, a second piezo element 67 is attached to the outside surface of the second arm piece 65. The first and the second piezo elements 66, 67 are constituted by, for example, a piezoceramic thin plate. The piezoceramic thin plate may be constituted by, for example, a piezoelectric material such as PNN-PT-PZ. The first and the second piezo elements 66, 67 are attached to the first and the second arm pieces 64, 65 on their inside surfaces. One end of the first and the second piezo elements 66, 67 is defined on the upstream side of the air inflow edge of the flying head slider 23 on the first and the second arm pieces 64, 65. The other end of the first and the second piezo elements 66, 67 is defined on the downstream side of the rotation axis RX. In this way, the first and the second piezo elements 66, 67 extend along the entire length of the first and the second arm pieces 64, 65.

First electrodes 66a, 67a are formed on the outside surface of the piezoceramic thin plates. The first and the second arm pieces 64, 65 are overlapped on the inside surfaces of the piezoceramic thin plates. As a result, the base piece 61, the fixed piece 62, the long piece 63, and the first and the second arm pieces 64, 65 constitute second electrodes of the first and the second piezo elements 66, 67. A conductive pattern 68 is separately connected to the electrodes 66a, 67a. A conductive adhesive may be used for the connection. The conductive pattern 68 may be formed on, for example, an insulation layer having a thickness of 10 μm. The insulation layer is constituted by a polyimide resin. The conductive pattern 68 extends toward the fixed plate 31.

The base piece 61, the fixed piece 62, the long piece 63, the first and the second arm pieces 64, 65, and the first and the second piezo elements 66, 67 are configured to be plane symmetric on a virtual plane including the rotation axis RX and extending in a front-back direction of the flying head slider 23. The base piece 61, the fixed piece 62, the long piece 63, and the first and the second arm pieces 64, 65 constitute an actuator main body 69. The actuator main body 69 is constituted by a single stainless steel plate. The thickness of the stainless steel plate is set to, for example, 50 μm. An etching processing is performed on the stainless steel plate in the manufacturing process. A contour of the actuator main body 69 is formed by the etching processing. The first and the second piezo elements 66, 67 are respectively attached to the first and the second arm pieces 64, 65. Thereafter, the first and the second arm pieces 64, 65 are formed on the basis of bending work. In the first and the second arm pieces 64, 65, the cylindrical surfaces 64a, 65a are formed on the basis of bending work of the top end portions.

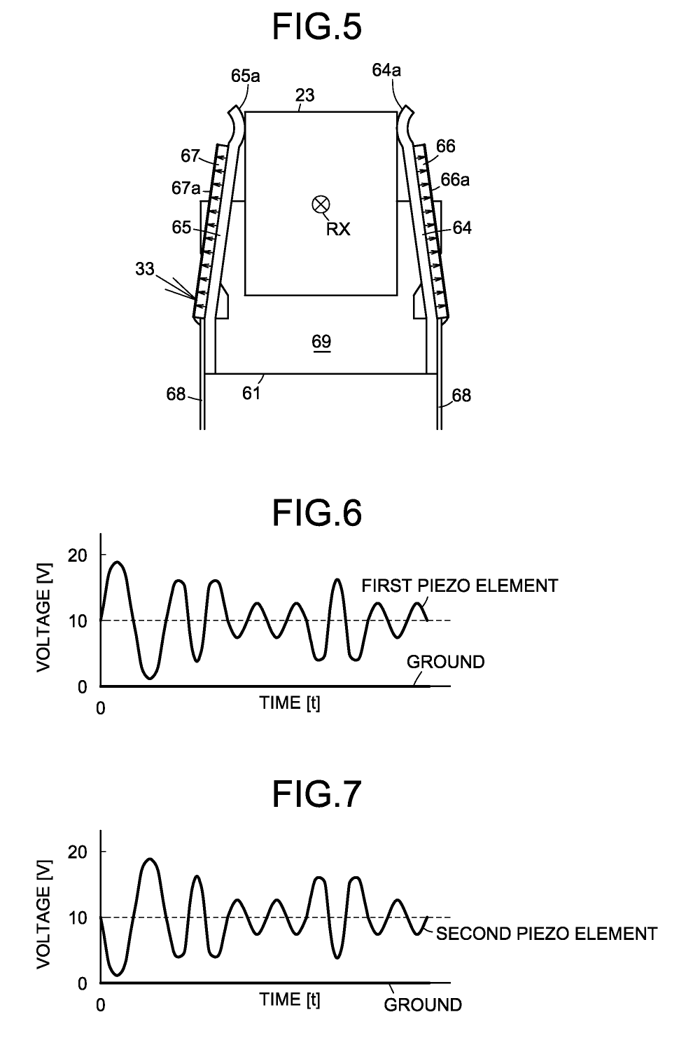

As illustrated in FIG. 5, the first piezo element 66 is polarized in the direction from the first arm piece 64 toward the electrode 66a. In a similar way, the second piezo element 67 is polarized in the direction from the second arm piece 65 toward the electrode 67a. When a drive voltage is applied to the electrodes 66a, 67a, the voltage is applied to the first and the second piezo elements 66, 67 in the opposite direction of the polarization direction. As a result, the first and the second piezo elements 66, 67 contract in the polarization direction. The first piezo element 66 expands along the surface of the first arm piece 64. The first arm piece 64 bends depending on the expansion of the first piezo element 66. The cylindrical surface 64a of the first arm piece 64 displaces toward the second arm piece 65. In a similar way, the second piezo element 67 expands along the surface of the second arm piece 65. The second arm piece 65 bends depending on the expansion of the second piezo element 67. The cylindrical surface 65a of the second arm piece 65 displaces toward the first arm piece 64.

Now, a case is considered in which the electromagnetic conversion element 34 on the flying head slider 23 is positioned on a recording track on the magnetic disk 14. Here, a controller chip in the HDD 11 applies a drive voltage to the first and the second piezo elements 66, 67. A maximum voltage value of 20 V is set for the drive voltage. The drive voltage varies between 0 V and 20 V. To start the control, a drive voltage of 10 V is applied to the first and the second piezo elements 66, 67. As a result, a driving force toward the second arm piece 65 is generated on the cylindrical surface 64a of the first arm piece 64. In a similar way, a driving force toward the first arm piece 64 is generated on the cylindrical surface 65a of the second arm piece 65. The two driving forces are balanced. As a result, the flying head slider 23 is held in an intermediate position, in other words, in a normal posture. As obvious from FIGS. 6 and 7, the drive voltage of the second piezo element 67 varies in a phase opposite to the drive voltage of the first piezo element 66.

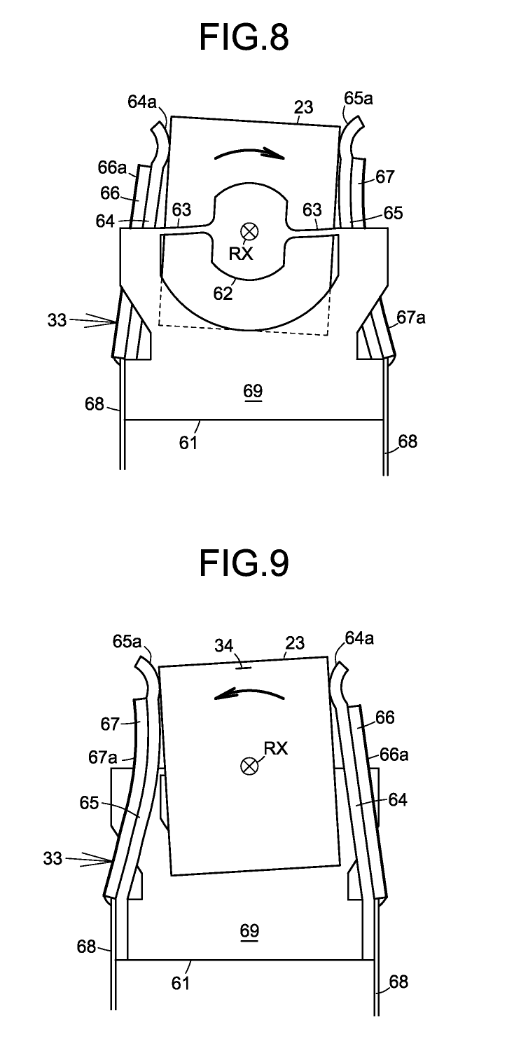

To start a tracking control, the read element reads a servo pattern from the magnetic disk 14. On the basis of the read servo pattern, an amount of deviation between the read head and the center line of the recording track is detected. Depending on the amount of deviation, the drive voltage increases from 10 V in the first piezo element 66, while the drive voltage decreases from 10 V in the second piezo element 67. The first piezo element 66 further expands along the surface of the first arm piece 64. The first arm piece 64 bends. The driving force from the cylindrical surface 64a toward the second arm piece 65 increases. On the other hand, the expansion of the second piezo element 67 is suppressed. The second arm piece 65 bends. The driving force from the cylindrical surface 65a toward the first arm piece 64 decreases. As a result, as illustrated in FIG. 8, the long pieces 63, 63 bend. The fixed piece 62, in other words, the flying head slider 23 is allowed to rotate clockwise around the rotation axis RX. At this time, the first arm piece 64 slides on the side surface of the flying head slider 23 at the cylindrical surface 64a. In a similar way, the second arm piece 65 slides on the side surface of the flying head slider 23 at the cylindrical surface 65a. As illustrated in FIG. 9, the flying head slider 23 rotates around the rotation axis RX from the normal posture. Depending on the rotation, the electromagnetic conversion element 34 can move in the radius direction of the magnetic disk 14. In this way, the deviation is intended to be eliminated.

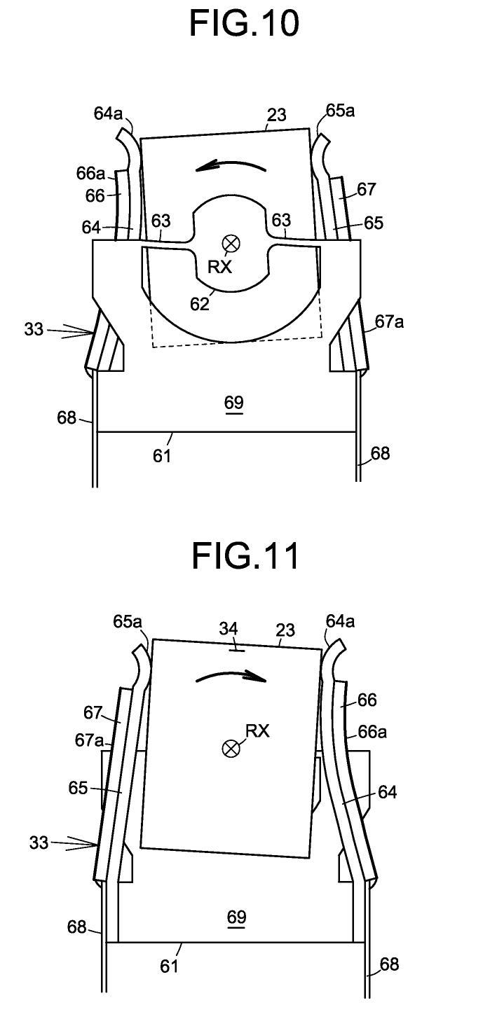

On the contrary, when the drive voltage decreases from 10 V in the first piezo element 66, the drive voltage increases from 10 V in the second piezo element 67. The expansion of the first piezo element 66 is suppressed. The first arm piece 64 bends. The driving force from the cylindrical surface 64a toward the second arm piece 65 decreases. On the other hand, the second piezo element 67 further expands along the surface of the second arm piece 65. The second arm piece 65 bends. The driving force from the cylindrical surface 65a toward the first arm piece 64 increases. As a result, as illustrated in FIG. 10, the long pieces 63, 63 bend. The fixed piece 62, in other words, the flying head slider 23 is allowed to rotate counter-clockwise around the rotation axis RX. At this time, the first arm piece 64 slides on the side surface of the flying head slider 23 at the cylindrical surface 64a. The second arm piece 65 slides on the side surface of the flying head slider 23 at the cylindrical surface 65a. In a similar way, as illustrated in FIG. 11, the flying head slider 23 rotates around the rotation axis RX from the normal posture. Depending on the rotation, the electromagnetic conversion element 34 can move in the radius direction, but which is opposite to the direction described above, of the magnetic disk 14. In this way, the deviation is intended to be eliminated. In this manner, the electromagnetic conversion element 34 can keep following the recording track with high accuracy.

In the head suspension assembly 21 as described above, the rotation of the flying head slider 23 is used for a minute movement of the electromagnetic conversion element 34. The first and the second arm pieces 64, 65 bend depending on the contraction and the expansion of the first and the second piezo elements 66, 67. As a result, the driving force acts from the first and the second arm pieces 64, 65 to the flying head slider 23. The driving force rotates the flying head slider 23 around the rotation axis RX. Since the first and the second arm pieces 64, 65 slidably contact the side surfaces of the flying head slider 23, the bending of the first and the second arm pieces 64, 65 is not restricted. Furthermore, the fixed piece 62 is separately partitioned from the first and the second arm pieces 64, 65. The shapes of the first and the second arm pieces 64, 65 are freely designed. As a result, a sufficient length is secured in the first and the second arm pieces 64, 65. The first and the second arm pieces 64, 65 can be transformed with large transformation amount. The displacement amount of the flying head slider 23 increases.

The effect of the first embodiment id verified as in the following. In the verification, simulation has been performed. In the simulation, two cases were prepared. For the first case, the head suspension assembly 21 described above was used. In the second case, the top ends of the first and the second arm pieces 64, 65 were attached to the side surfaces of the flying head slider 23 in the head suspension assembly 21 described above. In the two cases, the displacement amount of the flying head slider 23 was measured. As a result, in the second case, the electromagnetic conversion element 34 is displaced around the rotation axis RX with a displacement amount of 75 nm. In the second case, the electromagnetic conversion element 34 is displaced around the rotation axis RX with a displacement amount of 624 nm. In the first case, 8 times or more the displacement amount was secured compared with the second case. In accordance with the first embodiment, it was confirmed that the displacement amount of the flying head slider 23 is increased.

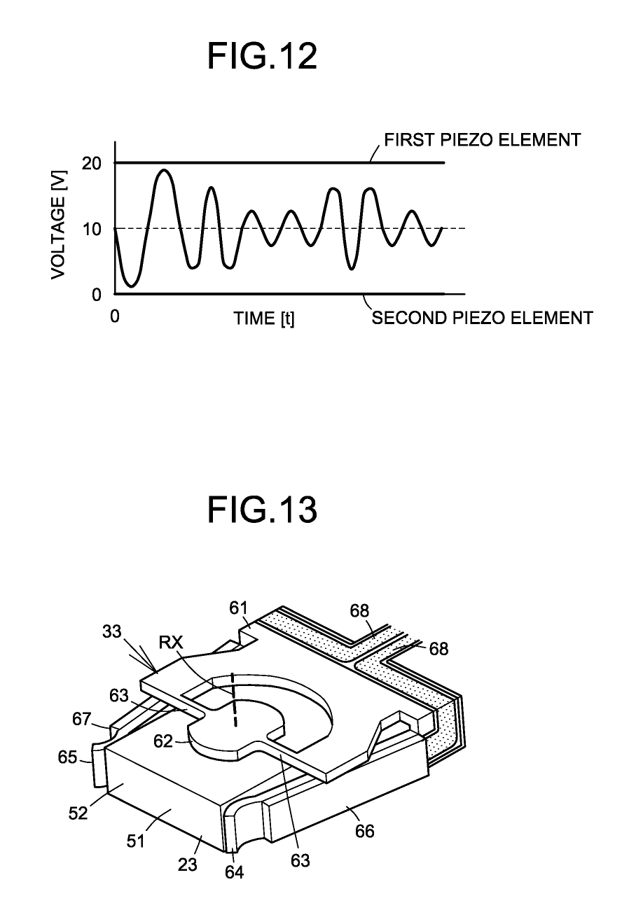

The expansion of the first and the second piezo elements 66, 67 may be controlled by the voltages applied to the first and the second arm pieces 64, 65. At this time, a voltage of 20 V is applied to the electrode 66a of the first piezo element 66. The electrode 67a of the second piezo element 67 is set to ground. For example, when a voltage of 10 V is applied from the base piece 61, a drive voltage of 10 V is applied from the electrode 66a toward the second arm piece 65 in the first arm piece 64. In a similar way, a drive voltage of 10 V is applied to the second arm piece 65 from the second arm piece 65 toward the electrode 67a. In this way, the flying head slider 23 is held in the normal posture in a similar way as described above. For example, as illustrated in FIG. 12, the voltage applied to the base piece 61 varies between 0 V and 20 V. In this way, the drive voltages applied to the first and the second piezo elements 66, 67 are adjusted. In addition, as illustrated in FIG. 13, the conductive pattern 68 may extend from the first and the second arm pieces 64, 65 along the surface of the base piece 61.

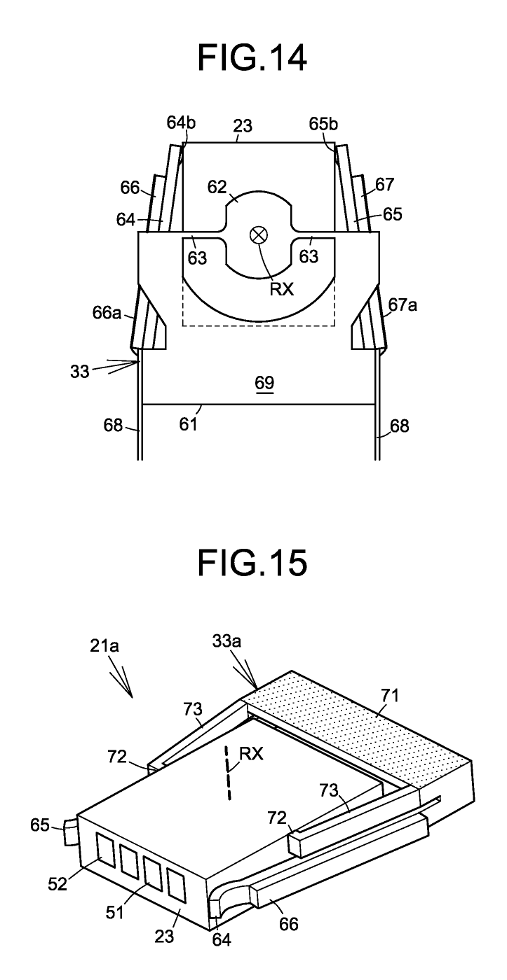

As illustrated in FIG. 14, the first and the second arm pieces 64, 65 may contact the side surfaces of the flying head slider 23 at a point on spherical surfaces 64b, 65b protruding toward the surface of the flying head slider 23, instead of using the cylindrical surfaces 64a, 65a described above. According to such a point contact and the line contact described above, the generation of friction between the first and the second arm pieces 64, 65 and the flying head slider 23 is avoided as much as possible when the top ends of the first and the second arm pieces 64, 65 slide. The driving force can be applied to the flying head slider 23 with high accuracy. As a result, the rotation of the flying head slider 23 is realized with high accuracy. The electromagnetic conversion element 34 can keep following the recording track with high accuracy.

As illustrated in FIG. 15, a micro actuator 33a is installed in a head suspension assembly 21a according to a second embodiment of the invention. The micro actuator 33a includes a base piece 71 having a flat-plate shape. The base piece 71 is attached to the gimbal 32 on the upstream side of the air inflow edge of the flying head slider 23. The base piece 71 extends along with the back surface of the flying head slider 23. The first and the second arm pieces 64, 65 are combined with the base piece 71 in the same way as the above.

The base piece 71 supports fixed pieces 72, 72. The fixed piece 72 is attached to the side surface of the flying head slider 23. Each fixed piece 72 is arranged on a virtual straight line perpendicular to the rotation axis RX in the width direction of the flying head slider 23. The base piece 71 and the fixed piece 72 are combined by a flexible long piece 73. The long piece 73 extends along a virtual plane defined in parallel with the rotation axis RX. The long piece 73 extends in parallel with the first and the second arm pieces 64, 65. One end of the long piece 73 is combined with the base piece 71 on the upstream side of the air inflow edge of the flying head slider 23.

The base piece 71, the fixed piece 72, the long piece 73, the first and the second arm pieces 64, 65, and the first and the second piezo elements 66, 67 are configured to be plane symmetric on a virtual plane defined in a front-back direction of the flying head slider 23 with the rotation axis RX being included. In the same way as the above, the base piece 71, the fixed piece 72, the long piece 73, and the first and the second arm pieces 64, 65 are constituted by a single stainless steel plate. The thickness of the stainless steel plate is set to, for example, 50 μm. The other constituent elements and structures equivalent to those described above are given the same reference numerals.

In this head suspension assembly 21a, the first and the second arm pieces 64, 65 bend depending on the contraction and the expansion of the first and the second piezo elements 66, 67. The driving force acts from the first and the second arm pieces 64, 65 to the flying head slider 23. By the action of the long pieces 73, 73, the flying head slider 23 is allowed to rotate. The driving force rotates the flying head slider 23 around the rotation axis RX. Since the first and the second arm pieces 64, 65 slidably contact the side surfaces of the flying head slider 23, the bending of the first and the second arm pieces 64, 65 is not restricted. Furthermore, the first and the second arm pieces 64, 65 are separately partitioned from the fixed piece 72. The shapes of the first and the second arm pieces 64, 65 are freely designed. A sufficient length is secured in the first and the second arm pieces 64, 65. The first and the second arm pieces 64, 65 can be transformed with large transformation amount. The displacement amount of the flying head slider 23 is increased. In addition, the base piece 71 extends along with the back surface of the flying head slider 23 on the upstream side of the air inflow edge of the flying head slider 23. The base piece 71 is not arranged between the flying head slider 23 and the gimbal 32. Increase of the thickness of the head suspension assembly 21a is avoided.

In the head suspension assembly or the storage medium drive apparatus according to any one of the aforementioned embodiments, the arm piece bends depending on the contraction and the expansion of the piezo element. The arm piece becomes in contact with the surface of the head slider in one end. The driving force acts from the arm piece to the head slider by the bending of the arm piece. The head slider is fixed to the fixed piece. The fixed piece is connected to the head suspension via the flexible long piece. The head slider is allowed to be displaced by the flexibility of the long piece. As a result, the head slider is displaced by the driving force. The arm piece slidably contacts the surface of the head slider, so that the bending of the arm piece is not restricted. Furthermore, the fixed piece is separately partitioned from the arm piece. The shape of the arm piece is freely designed. As a result, a sufficient length is secured in the arm piece. The arm piece can be transformed with large transformation amount. The displacement amount of the flying head slider increases.

Further, in the head suspension assembly according to any one of the aforementioned embodiments, the sufficient length is secured in the arm piece. The fixed piece is rotatably supported by the long piece. Therefore, the head slider is rotated based on the driving force that acts from the arm piece to the head slider. As described above, the displace amount, or namely the rotational amount of the head slider increases.

Still further, in the head suspension assembly according to any one of the aforementioned embodiments, the displacement of the head slider is realized based on the driving force acting from one arm piece toward the other arm piece. In a similar way, based on the driving force acting from the other arm piece toward the one arm piece, the displacement of the head slider is realized in the direction opposite to that of the above described case.

Still further, in the head suspension assembly according to anyone of the embodiments, by the line contact or the point contact, the generation of friction is avoided as much as possible between the arm piece and the head slider. The displacement of the head slider is realized with high accuracy.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head suspension assembly, comprising:
a head slider;
a plate attached to the head slider;
a flexible long portion extending from the plate and connected to a head suspension;
an arm connected to the head suspension at a first end and configured to slide in contact with a surface of the head slider at a second end; and
a piezo element attached to the arm.

2. The head suspension assembly of claim 1, wherein
the flexible long portion is configured to rotatably support the plate around a rotation axis perpendicular to a surface of the head slider facing a medium,
the first end of the arm is connected to the head suspension on an upstream side of an air inflow edge of the head slider, and
the second end of the arm is received by the surface of the head slider on a downstream side of the rotation axis.

3. The head suspension assembly of claim 1 further comprising a pair of arms, wherein the head slider is located between the pair of arms.

4. The head suspension assembly of claim 1, wherein the arm is linearly in contact with the head slider at a cylindrical surface around a center line parallel to the surface of the head slider.

5. The head suspension assembly of claim 1, wherein the arm is in contact with the head slider at a point on a spherical surface protruding toward the surface of the head slider.

6. A storage medium drive apparatus, comprising a head suspension assembly comprising:
a head slider facing a storage medium;
a plate attached to the head slider;
a flexible long portion extending from the plate and connected to a head suspension;
an arm connected to the head suspension at a first end and configured to slide in contact with a surface of the head slider at a second end; and
a piezo element attached to the arm.

7. The storage medium drive apparatus of claim 6, wherein
the flexible long portion is configure to rotatably support the plate around a rotation axis perpendicular to a surface of the head slider facing the storage medium,
a first end of the arm is connected to the head suspension on an upstream side of an air inflow edge of the head slider, and
a second end of the arm is received by the surface of the head slider on a downstream side of the rotation axis.

8. The storage medium drive apparatus of claim 6 further comprising a pair of arm pieces, wherein the head slider is located between the pair of arms.

9. The storage medium drive apparatus of claim 6, wherein the arm is linearly in contact with the head slider at a cylindrical surface around a center line parallel to the surface of the head slider.

10. The storage medium drive apparatus of claim 6, wherein the arm is contact with the head slider at a point on a spherical surface protruding toward the surface of the head slider.
